(19) United States
(12) Patent Application Publication
(10) Pub. No.: US 2004/0243533 A1
(43) Pub. Date: Dec. 2, 2004

(54) Method for interactively creating real-time visualizations of traffic information

(75) Inventors: Douglas G. Dempster, Andover, MA (US); Peter Cote, Littleton, MA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: WSI Corporation

(21) Appl. No.: 10/406,771

(22) Filed: Apr. 3, 2003

Related U.S. Application Data
(60) Provisional application No. 60/370,678, filed on Apr. 8, 2002.

(51) Int. Cl. G06F 7/00

(52) U.S. Cl. 707/1

(57) ABSTRACT

A method and system for providing substantially real-time, interactive presentation of traffic information related to a geographic region of interest. The system includes a database that stores information about traffic conditions registered to geographic locations, an input system that receives formatting and parameter inputs, a data interaction processor, and a visualization system that generates a display. The database is adapted to be interactively queried and the display is automatically updated to reflect the results of queries in accordance with traffic conditions stored in the database.

### CROSS-REFERENCE TO RELATED APPLICATIONS

This application is claims the benefit of priority of U.S. Provisional Patent Application No. 60/370,678, filed Apr. 8, 2002.

### FIELD OF THE INVENTION

The present invention generally relates to the field of information presentation systems. More particularly, the present invention relates to a system and method of near real-time, interactive presentation of random access, geographic and temporal information.

### BACKGROUND OF THE INVENTION

Conventional video and graphic presentation systems used for, e.g., traffic information broadcasts, require advance preparation of the visual presentation. This method is limited in that when newscasters are called upon to present information regarding traffic condition, the information being presented to viewers is not the most current available. While newscasters may endeavor to present current information, their graphical presentation may be 15 minutes old, or older, and the conditions sought to be presented may have changed in the interim, thus, frustrating drivers as they head out onto the highways.

Another problem with conventional systems is that they are not interactive. This inflexibility does not allow for changes during the airing of the presentation. Thus, if something should change between the preparation of the broadcast and airtime, or if the newscaster should decide at airtime that he or she would like show something different or further detail a portion of the display, the newscaster cannot interactively change the presentation and must prepare a new broadcast presentation, which often is not possible due to time constraints.

Thus, in view of the foregoing, there is a need for systems and methods that overcome the limitations and drawbacks of the prior art. In particular, there is a need for a system that provides real-time, interactive presentation of traffic information. The present invention provides such a solution.

### SUMMARY OF THE INVENTION

The present invention is directed to a method and system for providing a substantially real-time, interactive presentation of traffic information related to a geographic region of interest. The system includes a database that stores information about traffic conditions registered to geographic locations, an input system that receives formatting and parameter inputs, a data interaction processor, and a visualization system that generates a display. The database is adapted to be interactively queried and the display is automatically updated to reflect the results of queries in accordance with traffic conditions stored in the database.

In accordance with a feature of the invention, the database includes dynamic road segment information that is automatically input to the database. The parameter inputs may include at least one of a time and a geographic location for which the database is to be queried. In addition, the types of incident information to be displayed by the visualization system may be prioritized and filtering via the parameter inputs.

The display may include a map of a geographic location such that the traffic information extracted from the database is displayed in the appropriate geographic locations. The traffic data may be overlaid on the map and the display may further include elevation shaded terrain data, satellite imagery, Geographic Information Systems (GIS) data, and real-time weather information.

In accordance with another feature of the invention, iconic representations of current incidents at appropriate geographic locations may be displayed together with a visualization of the flow of traffic for each road segment in the database. In addition, the display may further include one of a tabular text box summarizing the traffic conditions for the set of roads currently being displayed and video which may be inset on the map.

In accordance with yet another feature of the invention, textual details of events may be provided that include at least one of an expected drive time between two points, a summary of current conditions prioritized by type, and details of flow rate for a road segment.

In addition, the system may provide a datastream that is communicated over the Internet or other wide area network. The datastream contains streaming video data adapted for receipt and display by client systems.

In accordance with yet another feature of the invention, the geographically registered data may include locations of cities, towns, counties, states and other geographic points of interest.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram illustrating an overview of the system of the present invention;

FIG. 2 is a flowchart illustrating the processes performed by the present invention to provide interactive presentation of data; and

FIGS. 3-8 illustrate several exemplary graphical presentations in accordance with the present invention.

### DETAILED DESCRIPTION OF PREFERRED EMBODIMENTS

The present invention is directed to a system for providing near real-time, interactive presentation of random access, geographic and temporal information for a location or region of interest. The system of the present invention allows newscasters to come on the air and interactively generate visual displays to convey traffic and road condition information to viewers without the need to prepare the entirety of the visual display in advance of airtime.

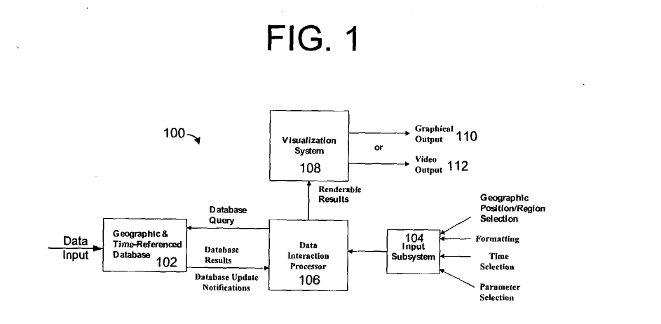

Referring now to FIG. 1, there is illustrated an overview of the system 100 of the present invention. The geographic and time-referenced database 102 receives and stores real-time data that is geographically registered, such as traffic information. The data may also include temporal characteristics, such that it is dynamic over time. The database 102 may contain information about traffic incidents such as, segment location (latitude/longitude), type (accident, construction, oil spill, etc.), duration (start time, end time), severity, nearest intersection, etc. The database 102 may also include static road segment information, such as name (“I6 between I490 and I38”), capacity (lanes, cars/hour), and location (collection of latitude/longitude pairs). The database 102 may further contain dynamic road segment information, such as, segment name, current or historical traffic flow rate (cars/hour, bi-directional), and road conditions (wet, snow covered, etc.). Further, the database 102 may contain information regarding city, town, county and state boundaries or locations.

The data provided to the database 102 may come from several sources and is preferably input in real-time. For example, the data may be manually input to the database 102 from visual observations made by drivers or via cameras. The data may be automatically input from sensors in or near road surfaces, reading toll tags, etc. Further, the data may be feed to the database 102 from changeable traffic signs (CTS) that are used provide information to drivers. For example a CTS on the New Jersey Turnpike may indicate that the Holland Tunnel is congested and provide an alternate route.

An input subsystem 104 is provided to receive input from a user, such as a geographic position/region selection, formatting inputs, a time selection, and a parameter selection (e.g., weather, traffic, warnings, current observations, etc.). The user input may come from a personal computer running the appropriate software to generate inputs that may be received and processed by the system 100 via a data interaction processor 106. For example, this input may come from the user via a mouse, a typed command at a keyboard, from an interactive device such as a computer touch screen, a visual tracking system, etc.

The user inputs may include, but are not limited to, a selection of one or more parameters that are to be extracted from the underlying geographic database 102. The inputs may specify to the processor 106 a specific time or a time range for which the database is to be queried, or a geographic position or region for which the data is to be queried in accordance with the user input. Formatting may be specified that indicates how information is to be displayed. The formatting may include a presentation format (e.g., textual versus iconic), and graphical attributes such as font or line width. Given these inputs, the data interaction processor 106 performs a query of the database 102, formats the information based on the selected format specification, and presents the results to a visualization system 108 for presentation.

The visualization system 108 for this system 100 can be any computer graphics system capable of generating graphical representations of geographic information such that that representation can be displayed on broadcast television, cable or other transmission media. An example of such a system is the TrueView System provide by WSI Corporation, Billerica, Mass. The visualization system 108 is graphical in nature and presents, e.g., a map of a particular geographic area and turns coded information extracted from the database 102 via the data interaction processor 106 into a graphical display. For example, traffic flow data may be input to the visualization system 108, which in turn is output as a color-coded set of moving arrows representative of the flow rate as shown in several of Figs. The visualization system 108 includes both video and graphical outputs 110 and 112, which may be used for broadcast television, or to provide a datastream communicated over the Internet or other wide area network for use by visitors to websites (e.g., personal computers running Web Browsers and/or Flash players, etc.).

The system 100 may automatically generate a geographical map display showing a subset of the real-time traffic information. Incident and road segment data may be overlaid on a geographically accurate map display that may include: elevation shaded terrain data, satellite imagery, Geographic Information Systems (GIS) data (e.g., road, buildings, shopping areas, other points of interest), and real-time weather information. The real-time traffic information may include: an iconic representation of all current incidents, where each icon is plotted at the appropriate geographic location, a visualization of the flow of traffic for each segment in the database 102 using colorization and/or animation to indicate rate, a tabular text box summarizing the traffic conditions for the set of road currently being displayed, or live video which may be inset on a map. Dots, icons, or other markers may be shown on a map, that when clicked, show live video of a broadcast of the current traffic conditions. Tabular representations may be generated that may show a prioritized list of incidents and their associates status, a list of popular routes and their status, and a list of well-known “drive segments” and the estimated time to make the drive. Graphical representations may include drive times for popular road segments versus historical averages or drives times for alternate routes versus each other.

Prior to airtime, the user has the ability to tailor the graphical representation of the traffic by prioritizing and/or filtering the types of incident information to be displayed. The user may select the graphical representation and/or attributes for the traffic information, region of coverage for the map display, and define graphical attributes of the GIS database such as line widths, colors and iconic representations for point features.

The present invention advantageously provides the user with the ability to interactively query the data in the database 102 and present the results in near real-time to the viewing audience. Such queries may include providing textual details of a graphically represented incident, calculating the expected “drive time” between two points, a summary of current conditions prioritized by type, textual details of flow rate for a road segment, or a search feature wherein the map “zooms” to a particular location. This information is generated automatically through a sequence of map visualizations showing current traffic information for a predefined set of locations or a sequence of map visualizations generated from current traffic information for selected incident types in the database 102. Thus, the system 100 of the present invention can provide an on-air presentation that is continuously and automatically updated to reflect the real-time data in the database 102 (e.g., accidents clearing, road segments becoming more congested).

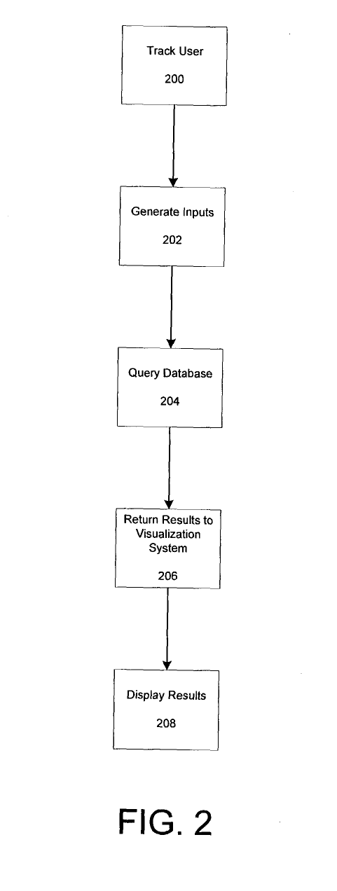

FIG. 2 provides a flowchart of the operation of the system 100. In operation, the system 100 may take user input from a visual tracking device, as known in the art, to track, e.g., the user's finger (step 200). For example, the user may point to a particular geographic location to obtain the current traffic conditions at that location. The data interaction processor 106 receives the input from the input subsystem 104 (step 202), and formulates the appropriate query of the database 102 (step 204). The database 102 returns the result of the query to the data interaction processor 106, which sends the result to the visualization subsystem 108 (step 206). The results are then output via graphical or video outputs 110 and 112 for broadcast or transmission (step 208). It is noted that steps 200-208 are performed in near real-time such that when a newscaster points to a particular location, the requested data is substantially immediately presented for display, without the need for preparing the broadcast presentation in advance of air time. Thus, any data stored in the database 102 may be interactively presented.

Throughout the processes of FIG. 2, the data interaction processor 106 is also monitoring updates to the database 102, such that any changes to the database 102 will be reflected in on the on-air representation, for example, to indicate that a new traffic accident has occurred.

In accordance with an alternate operation of the present invention, the user predetermines a set of criteria regarding items of interest (e.g., accidents, but not breakdowns, areas of severe congestion but not normal flow). The system 100 then monitors the database 102 and generates a dynamic sequence of map displays showing only those geographic regions that are affected. Such a system advantageously provides for an automated 24×7 traffic display system.

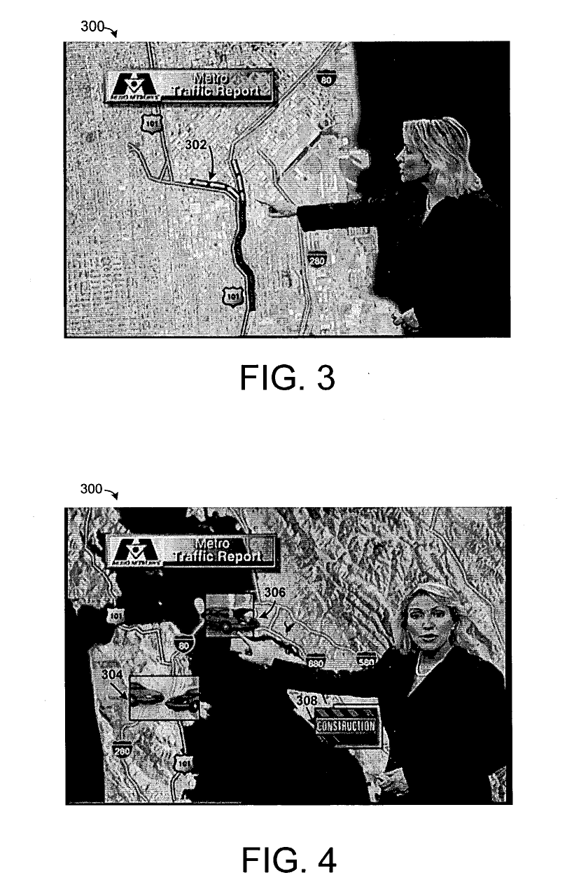

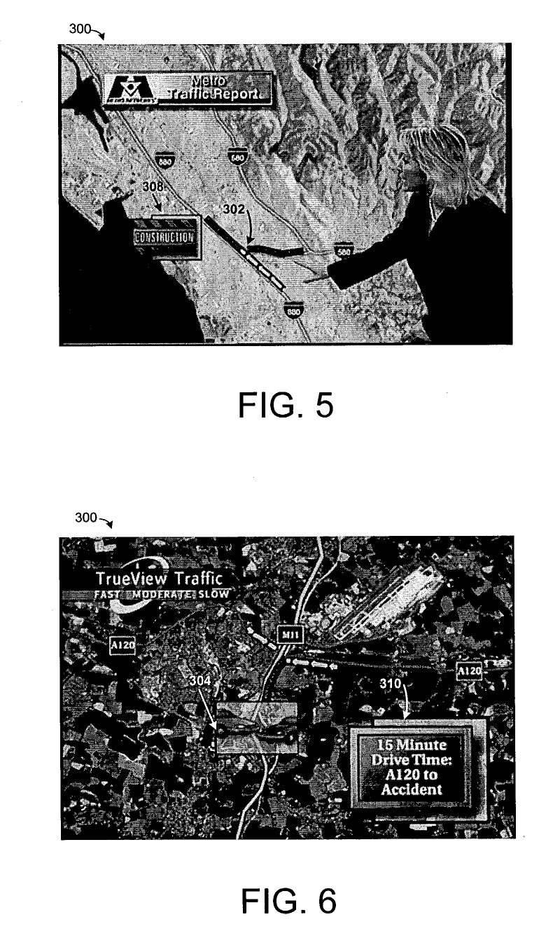

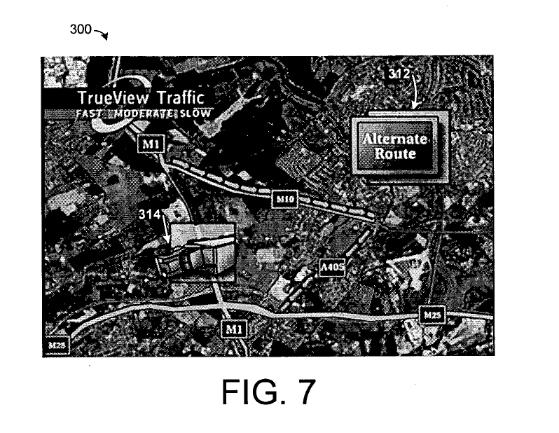

Referring to FIGS. 3-8, there is illustrated exemplary presentations 300 generated by the system 100 showing avatars 302-314. In this context, an avatar is a graphical object having characteristics that change over time based on data updates to the database 102, a change in geographic position, a change in the time of day for which the avatar is presenting information, etc.

Examples of avatars are a series of color coded arrows that move in the direction of traffic flow at a rate proportional to the speed of traffic (avatar 302), thus conveying a level of congestion. For example, yellow arrows show moderate congestion, whereas red arrows show heavy congestion. Avatars 304, 306, 308 and 314 show traffic incidents, such as accidents, break downs and construction. Avatars 310 and 312 show other information such as “drive times” and alternate route information to avoid accidents, etc.

While the present invention has been described in connection with the preferred embodiments of the various Figs., it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A system for providing a substantially real-time, interactive presentation of traffic information related to a geographic region of interest, comprising:
a database that stores information about traffic conditions registered to geographic locations;
an input system that receives formatting and parameter inputs;
a data interaction processor; and
a visualization system that generates a display,
wherein said database is adapted to be interactively queried, and
wherein said display is automatically updated in accordance with traffic conditions stored in said database.

2. The system of claim 1, wherein said database includes dynamic road segment information automatically input to said database.

3. The system of claim 1, wherein said parameter inputs include at least one of a time and a geographic location for which the database is to be queried.

4. The system of claim 3, wherein types of incident information to be displayed by said visualization system is prioritized and filtering via said parameter inputs, and wherein said display is automatically updated to reflect changes in the database.

5. The system of claim 1, wherein said display includes a map of a geographic location and said traffic information extracted from said database is geographically registered to locations on said map.

6. The system of claim 5, wherein said traffic data is overlaid on said map and said display further includes at least one of elevation shaded terrain data, satellite imagery, Geographic Information Systems (GIS) data, and real-time weather information.

7. The system of claim 5, wherein said display includes an iconic representation of current incidents at appropriate geographic locations and a visualization of the flow of traffic for each road segment in said database.

8. The system of claim 5, wherein said display further includes one of a tabular text box summarizing the traffic conditions for the set of road currently being displayed and video which may be inset on said map.

9. The system of claim 8, wherein textual details of a graphically represented incident are presented.

10. The system of claim 9, wherein said textual details include at least one of an expected drive time between two points, a summary of current conditions prioritized by type, and details of flow rate for a road segment.

11. The system of claim 1, further comprising a datastream that is communicated over a wide area network, wherein said datastream contains streaming video data adapted for receipt and display by client systems.

12. The system of claim 1, wherein said visualization system generates graphical representations of traffic information such that the representation is suitable for display via broadcast distribution media.

13. A method of generating substantially real-time, interactive presentations of traffic information related to a geographic region of interest, comprising:
receiving traffic-related data in a database;
formulating a query in accordance with input parameters;
returning results of said query to a visualization system;
automatically updating a display generated by said visualization system to reflect the results of queries in accordance with traffic-related data stored in said database.

14. The method of claim 13, further comprising prioritizing and filtering types of traffic-related data to be displayed.

15. The method of claim 13, further comprising overlaying said traffic-related data with at least one of elevation shaded terrain data, satellite imagery, Geographic Information Systems (GIS) data, and real-time weather information.

16. The method of claim 13, further comprising:
providing an iconic representation of current incidents at appropriate geographic locations; and
providing a visualization of the flow of traffic for each road segment in said database.

17. The method of claim 13, further comprising:
providing a tabular text box summarizing the traffic conditions for the set of road currently being displayed, wherein said text box includes at least one of details of a traffic incident, an expected drive time between two points, a summary of current conditions prioritized by type, and details of flow rate for a road segment.

18. The method of claim 13, further comprising:
providing a datastream that is communicated over a wide area network, wherein said datastream contains streaming video data adapted for receipt and display by client systems.

19. The method of claim 13, further comprising broadcasting said visualization via broadcast distribution media.

20. A method of generating substantially real-time, interactive presentations of traffic information related to a geographic region of interest, comprising:
receiving traffic-related data in a database;
defining a prioritization of types of traffic-related data to be presented;
automatically generating and updating a display to reflect said traffic-related data stored in said database as said traffic-related data is updated in said database.

21. The method of claim 20, further comprising overlaying said traffic-related data with at least one of elevation shaded terrain data, satellite imagery, Geographic Information Systems (GIS) data, and real-time weather information.

22. The method of claim 20, further comprising providing a tabular text box summarizing the traffic conditions for the set of road currently being displayed, wherein said text box includes at least one of details of a traffic incident, an expected drive time between two points, a summary of current conditions prioritized by type, and details of flow rate for a road segment.

23. The method of claim 20, further comprising:
prioritizing and filtering said traffic-related data to be displayed; and
automatically generating a sequence of map views based on current data in said database.
